(19) United States
(12) Patent Application Publication
(10) Pub. No.: US 2017/0136488 A1
(43) Pub. Date: May 18, 2017

(54) Pressurized Paint Applicator Device

(71) Applicant: Thieu Huy Tran, Calgary (CA)

(72) Inventor: Thieu Huy Tran, Calgary (CA)

(21) Appl. No.: 14/943,050

(22) Filed: Nov. 17, 2015

(51) Int. Cl. B05C 17/005; B05C 11/10

(52) U.S. Cl. CPC B05C 17/00573; B05C 17/00516; B05C 11/1026; B05C 11/1039

(57) ABSTRACT

A pressurized paint applicator device for delivering paint or other coating under pressure to an applicator for application to a surface. The invention further provides an improved applicator that has a conically-shaped bottom side that is particularly advantageous for cutting in paint edges.

### FIELD OF THE INVENTION

The present invention relates generally to surface coating applicators, and more particularly, relating to pressurized paint applicator device.

### BACKGROUND OF THE INVENTION

Pressurized surface coating applicator devices are known. Examples of such devices are described in U.S. Pat. Nos. 4,611,940; 3,602,601; 2,677,839; and 2,627,620 each of which are incorporated herein in their entirety by reference. While the devices heretofore fulfill their respective, particular objectives and requirements, there exists and need for an improved pressurized surface coating device, which substantially departs from the prior art, and in doing so provides an apparatus primarily developed for the purpose of cutting in paint edges.

### SUMMARY OF THE INVENTION

The present invention provides an improved pressurized paint applicator device that is particularly useful in cutting in paint edges.

In general, in one aspect, a pressurized paint applicator device is provided. The pressurized paint applicator device includes an applicator having a top side and a conically-shaped bottom side and at least one distributor tube having an open end that is directed toward the bottom side of said applicator.

In general, in another aspect, a pressurized paint applicator device is provided. The pressurized paint applicator device includes an applicator with a top side and a conically-shaped bottom side. At least one distributor tube has an open end that is directed toward the bottom side of the applicator. The device further includes a pressure tank and an air pump connected to the pressure tank and operable to pump air into the pressure tank. A supply tube is connected at one end to the pressure tank and is connected at its opposite end to the at least one distributor tube. A valve is connected to supply tubing and is operable to control a flow through the supply tubing. A bracket is rotatably connected to the top side of the applicator and a handle is pivotally connected to the bracket.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a diagrammatic view of a pressurized paint applicator device constructed in accordance with the principles of an embodiment of the present invention;

FIG. 2 is a partial, cross-sectional view through a handle of a pressurized paint applicator device constructed in accordance with the principles of an embodiment of the present invention;

FIG. 3 is a top plan view of an applicator of a pressurized paint applicator device constructed in accordance with the principles of an embodiment of the present invention;

FIG. 4 is a front elevation view of an applicator of a pressurized paint applicator device constructed in accordance with the principles of an embodiment of the present invention;

Figure is a bottom plan view of an applicator of a pressurized paint applicator device constructed in accordance with the principles of an embodiment of the present invention;

FIG. 6 is a cross-sectional view of the applicator taken along line 6-6 of FIG. 3;

FIG. 7 is a perspective view of an applicator pad of an applicator of a pressurized paint applicator device constructed in accordance with the principles of an embodiment of the present invention;

FIG. 8 is a diagrammatic in-use view of an applicator of a pressurized paint applicator device constructed in accordance with the principles of an embodiment of the present invention;

FIG. 9 is a diagrammatic elevation view of a pressure tank having an alternative construction in accordance with an embodiment of the present invention;

FIG. 10 is a diagrammatic top view of the pressure tank of FIG. 9; and

FIG. 11 is a diagrammatic cross sectional view of the pressure tank of FIG. 9 taken along line 11-11 in FIG. 10.

### DETAILED DESCRIPTION OF THE INVENTION

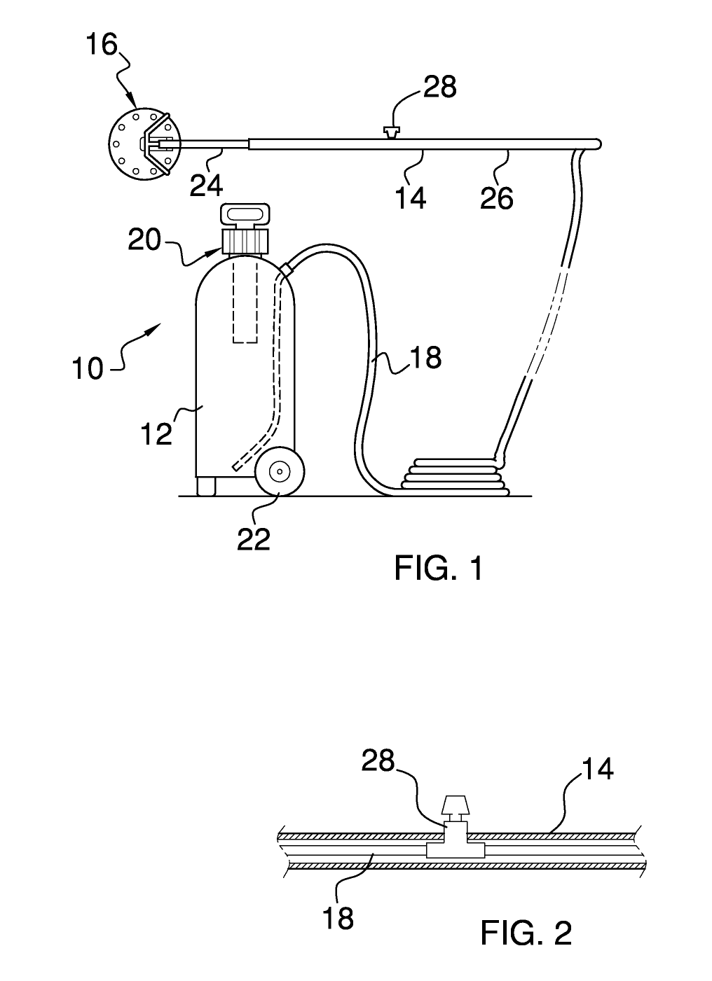

Referring now to the drawings, and more particularly to FIGS. 1-5, diagrammatically shown therein and designated by the reference number 10 is an embodiment of the present pressurized paint dispenser and applicator.

With reference to FIG. 1, in the illustrated embodiment, the paint dispenser and applicator 10 includes a pressure tank 12, a handle 14, an applicator 16, and a paint supply tube or line 18. The pressure tank 12 is capable of receiving and holding paint and into which air may be pumped to pressurize the tank for discharging the paint from the tank. As shown, tank 12 is fitted with a manually operated air pump 20 that is operable by a user to pump air into the tank. Tanks of this type are commonly used in portable spraying equipment and are well adapted for this purpose. Alternatively, and while not shown, air pump 20 could be replaced with an electrically operated air pump. Additionally, tank 12 may have wheels 22 allowing the tank to be wheeled for transport.

Handle 14 is an elongated extension-type handle have an adjustable length by extending or retracting handle portion 24 from handle portion 26. As further discussed below, the handle 14 is connected to the applicator 16 for manipulating the applicator in applying a coating to a surface. Supply tube 18 is connected at one end to the tank 12 and connected at its opposite end to the applicator 16 to deliver paint from the tank to the applicator for applying the paint to a surface. As shown, the supply tube 18 is extends within and through the entire handle 14, but it should be understood that the supply tube could extend exteriorly of the handle or interiorly along any desired length of the handle. As further shown in the illustrated embodiment, valve 28 is provided to control the flow of paint from the tank 12 to the applicator 16.

Turning to FIG. 2, there is shown a partial cross section through a section of the handle 14, illustrating the supply tube 18 extending within the interior of the handle. Further shown is valve 28 connected to the supply 18. Valve 28 is operable to control the flow of paint through the tube, and thus the delivery of paint from the tank 12 to the applicator 16.

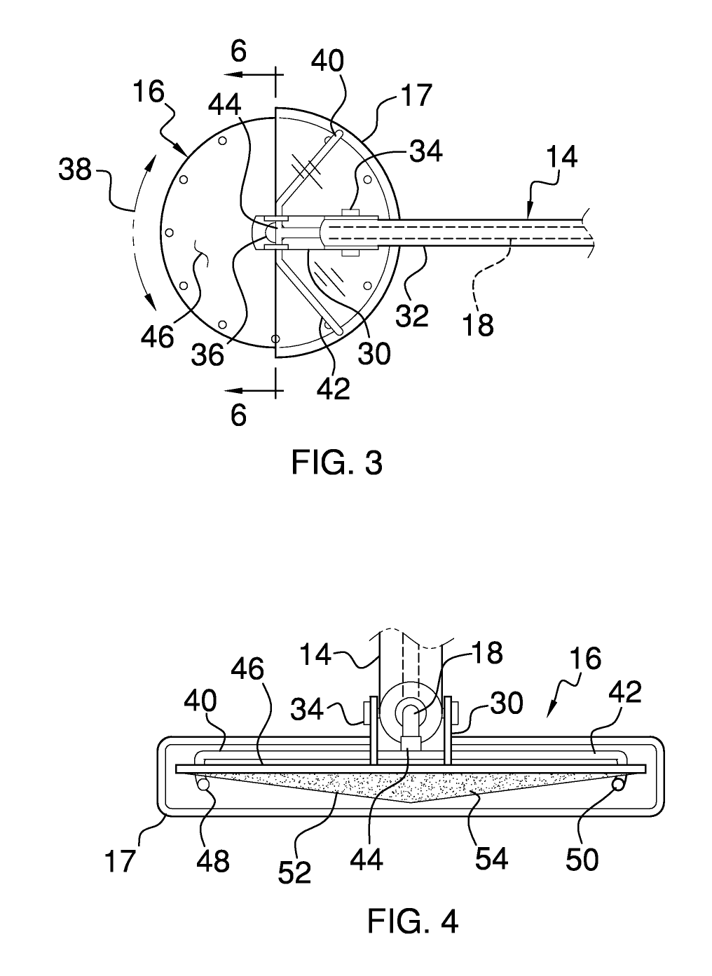

With reference now to FIG. 3, there is shown a top view of the applicator 16 connected to the handle 14. Handle 14 is connected to the applicator 16 by bracket 30 or the like. More specifically, end 32 of handle 14 is pivotally connected to bracket 30 by pivot coupling 34 that permits the applicator to pivot about the end of the handle. Additionally, bracket 30 is rotatably connected to the applicator 16 by coupling 36 that permits the applicator to rotate relative to the handle in the direction indicated by double-ended arrow 38. To this end, the applicator 16 is able to rotate and pivot with respect to the end 32 of handle 14. Further illustrated is the supply tube 18 connected to distributor tubes 40 and 42 via junction 44. Distributor tubes 40 and 42 are supported by bracket 30 and extend in opposite directions from junction 44 toward the edge of the applicator 16 in a swept, downward direction (in a direct toward the handle).

Turning now to FIG. 4, there is shown a front elevation view of the applicator 16, illustrating the distributor tubes 40 and 42 extending across the top side 46 and beyond the edge of the applicator and wrapping around the edge and terminating at open ends 48 and 50, respectively, which are directed toward the bottom side 52 of the applicator. Further shown is the bottom side 52 of the applicator being conical-shaped and having an applicator pad 54 secured to the bottom side.

In FIG. 5, there is shown a bottom plan view of the applicator 16, further showing the distributor tubes 40 and 42 wrapped around the edge of the applicator and overlapping the bottom side 52 of the applicator and terminating at open ends 48 and 52, respectively, for distributing paint on to the applicator pad 54 that is attached to the bottom side of the applicator.

Further, as seen in FIGS. 3-5, the applicator 16 may include a drip collection box 17 that is semi-circular shaped and configured to catch excess paint that may drip from the applicator pad 54 or tubes 40 and 42. As shown, the drip collection box 17 is attached and supported by bracket 30 and is disposed to envelope the portion of the applicator pad 54 that is rotated into a position that is approximate the handle 14. As further shown, the drip collection box 17 envelopes the tubes 40 and 42 to further collect any paint that may drip from the tubes. Additionally, the drip collection box 17 may be constructed of a transparent material, as depicted.

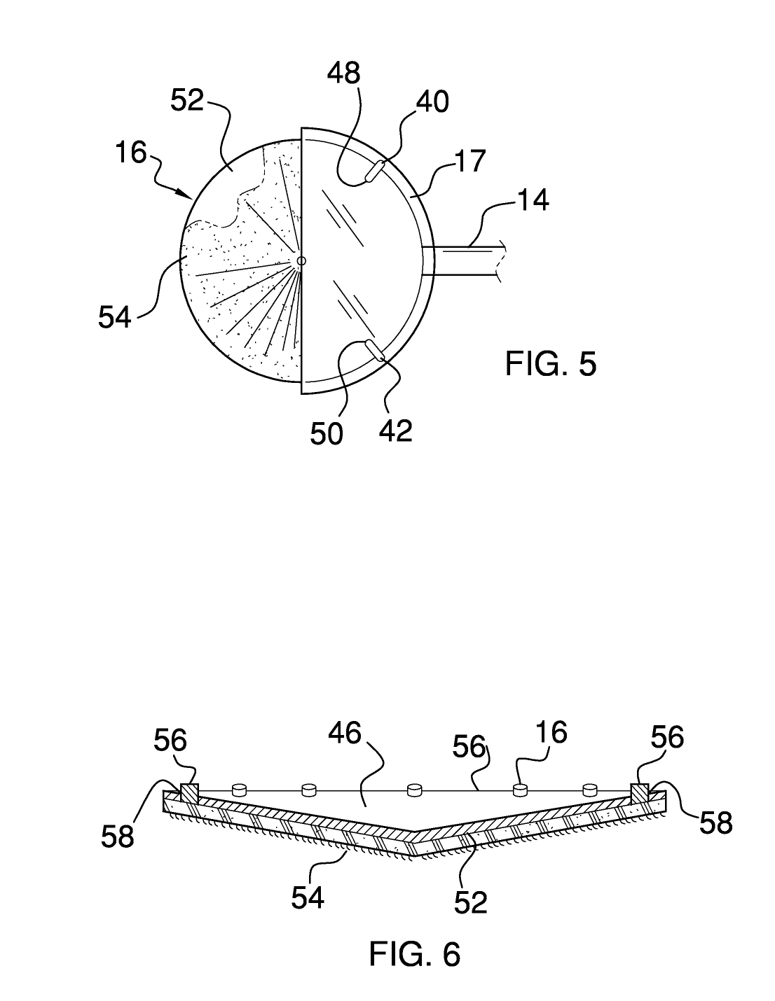

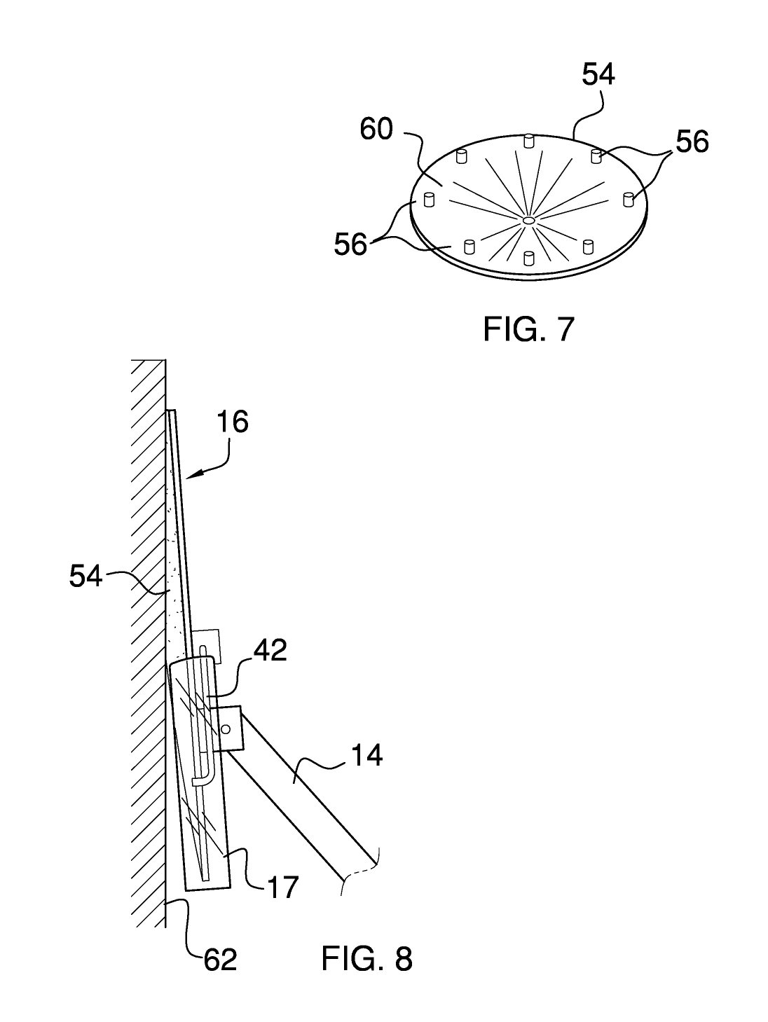

With reference now to FIGS. 3 and 6, the applicator pad 54 is secured or attached to the bottom side 52 of the applicator 16. In the illustrated embodiment, the applicator pad 54 includes a plurality of pegs 56 that extend upwardly from the inward facing side of the pad and are spaced around the edge of the pad. The applicator 16 includes a plurality of cooperating holes 58 into which are received the pegs 56 so as to removable secure the applicator pad 54 to the bottom side 52 of the applicator. It should be understood that other means for removably attaching the applicator pad 54 to the bottom side 52 of the applicator 16 could be used in place of the illustrated peg-and-hole arrangement. It is further to be understood that the applicator pad 54 is constructed of an absorbent material for receiving coating to be applied to a surface. In FIG. 7, there is shown a perspective view of the applicator pad 54, showing the pegs 56 extending outwardly from the interior surface 60 of the applicator pad.

Turning now to FIG. 8, there is shown the applicator 16 in use and positioned on a surface 62 to be coated, wherein the importance of the conically-shaped bottom side 52 of the applicator is illustrated. Specifically, the conical-shape allow use of only a portion of the applicator pad 54 for trimming-in along the surface 62, while prevent contact with the surface with the other portion of pad. This arrangement allows for a more accurate trim and prevents contact between the distributor tubes 40 and 42 with the surface.

In use, it can now be understood, paint or other coating is placed into the tank 12 and air is pumped into the tank to pressurize the tank. In the illustrated embodiment, air is pumped into the tank 12 via manual pump 20. The pressure within the tank 12 causes paint to flow through the supply tubing 18 to the valve 28. Then operating the valve 28 allows the paint to flow into the distributor tubes 40 and 42, where the paint is discharged upon the applicator pad 54. After the paint is applied to the applicator pad 54, the pad is rotated about coupling 36 to position the coated portion of the pad away from the distributor tubes for application to a surface.

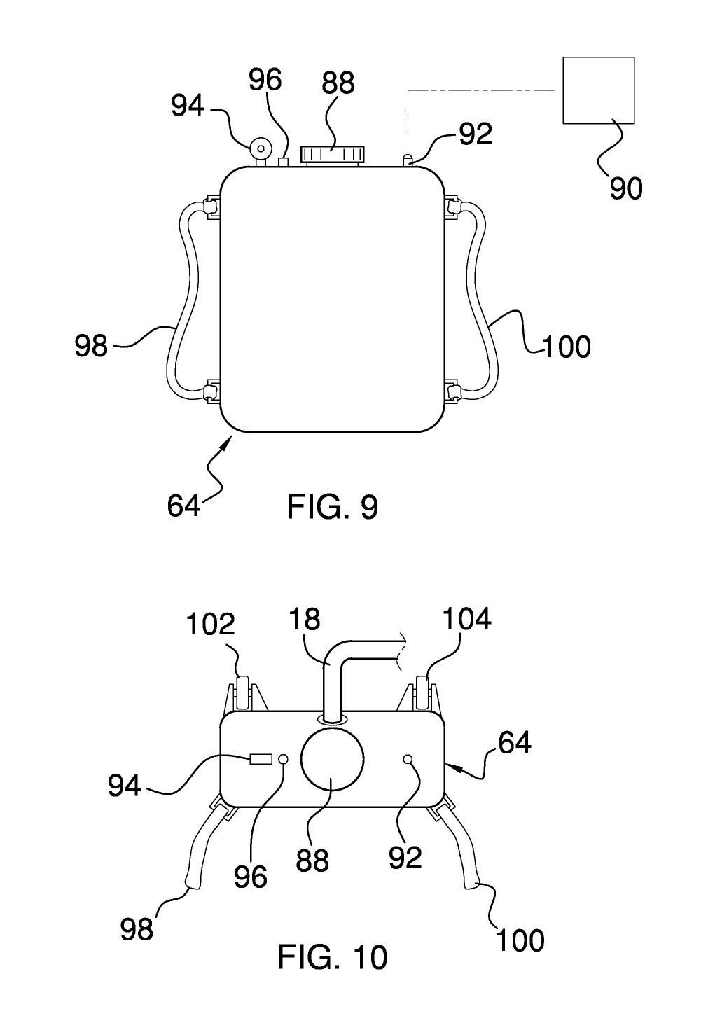

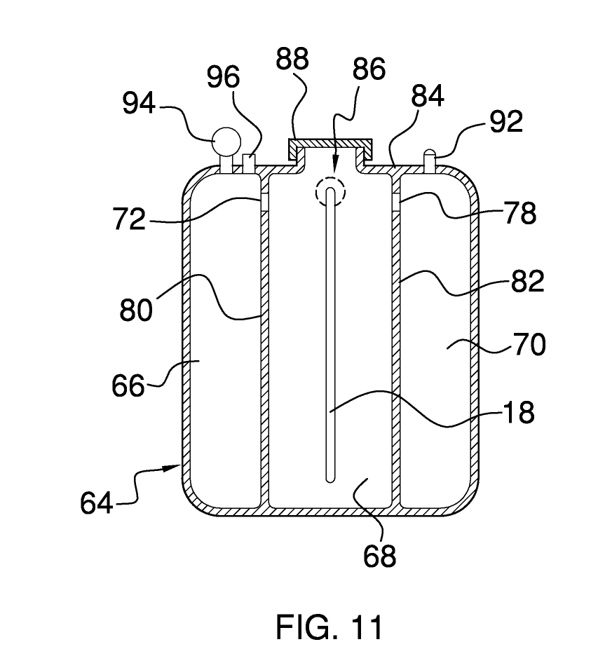

Alternative embodiments are possible. With reference to FIGS. 9-11 there is diagrammatically illustrated a pressure tank 64 having an alternative construction from pressure tank 12.Pressure tank 64 is generally rectangular shaped and is interiorly divided into three tank sections 66, 68, and 70, with tank section 68 disposed between tank sections 66 and 70. Tank sections 66, 68, and 70 are in fluidic communication by apertures 72 and 78 that are formed through interior dividing walls 80 and 82, respectively, at a position toward the top 84 of the tank 64.

The middle tank section 68 receives and holds a quantity of paint or other surface coating to be applied to a surface by fill opening 86 formed through the top of the tank 64 and sealed by cap 88. Supply tube 18 sealing extends through the side of the tank 64 and extends into and toward the bottom of tank section 68 to draw paint from tank section 68

Tank sections 66 and 70 are pressurized with air via an air pump 90 that is detachably connected to air valve stem 92, which communicates with the interior of the tank 64. Apertures 72 and 78 allow the air to communicate between tank sections 66, 68, and 70 so that tank section 68 is also pressurized. Tank 64 may be fitted with a pressure gauge 94 to indicate the pressure of the tank and may be fitted with a pressure release valve 96 that automatically operates to vent air from the tank in an over pressurized.

Pressure tank 64 may also be fitted with shoulder straps 98 and 100 that allow carrying the tank upon a user's back. Additionally, the pressure tank 64 may also include wheels 102 and 104 that allow rolling the tank across the ground.

A number of embodiments of the present invention have been described. Nevertheless, it will be understood that various modifications may be made without departing from the spirit and scope of the invention. Accordingly, other embodiments are within the scope of the following claims.

What is claimed is:

1. A pressurized paint applicator device comprising:
an applicator having a top side and a bottom side, wherein said bottom side is conical shaped; and
at least one distributor tube having an open end that is directed toward said bottom side of said applicator.

2. The pressurized paint applicator device of claim 1, wherein said applicator has a peripheral edge and wherein said at least one distributor tube is wrapped around said peripheral edge.

3. The pressurized paint applicator device of claim 1, further comprising:
a pressure tank;
an air pump connected to said pressure tank and operable to pump air into said pressure tank;
a supply tubing connected at one end to said pressure tank and connected at its opposite end to said at least one distributor tube;
a valve connected to supply tubing and operable to control a flow through said supply tubing; and
a handle, wherein said applicator is attached to an end of said handle.

4. The pressurized paint applicator device of claim 3, wherein said applicator has a peripheral edge and wherein said at least one distributor tube is wrapped around said peripheral edge.

5. A pressurized paint applicator device comprising:
an applicator having a top side and a bottom side, wherein said bottom side is conical shaped;
at least one distributor tube having an open end that is directed toward said bottom side of said applicator;
a pressure tank;
an air pump connected to said pressure tank and operable to pump air into said pressure tank;
a supply tube connected at one end to said pressure tank and connected at its opposite end to said at least one distributor;
a valve connected to supply tubing and operable to control a flow through said supply tubing;
a bracket, said bracket rotatably connected to said top side of said applicator; and
a handle pivotally connected to said bracket.

6. The pressurized paint applicator device of claim 5, wherein said applicator has a peripheral edge and wherein said at least one distributor tube is wrapped around said peripheral edge.

7. The pressurized paint applicator device of claim 5, wherein said at least one distributor tube is supported by said bracket and extends across said top side of said applicator and is wrapped around a peripheral edge of said applicator.

8. The pressurized paint applicator device of claim 5, wherein said handle is an elongated, extension handle.

9. The pressurized paint applicator device of claim 5, further comprising:
wheels attached to said pressure tank.

10. A pressurized paint applicator device comprising:
a circular applicator having a top side and a bottom side, wherein said bottom side is conical shaped;
a pair of distributor tubes extending across said top side in opposite directions, each wrapping around a peripheral edge of said applicator and terminating at an open end directed toward said bottom side;
a pressure tank;
an air pump connected to said pressure tank and operable to pump air into said pressure tank;
a supply tube connected at one end to said pressure tank and connected at its opposite end to each distributor tube of said pair of distributor tubes;
a valve connected to supply tubing and operable to control a flow through said supply tubing;
a bracket, said bracket rotatably connected to said top side of said applicator; and
a handle pivotally connected to said bracket.
